(19) United States
(12) Patent Application Publication
(10) Pub. No.: US 2026/0253345 A1
(43) Pub. Date: Aug. 27, 2026

(54) DEVICE AND METHOD FOR AUGMENTING A SCENE

(71) Applicant: Koninklijke KPN N.V., Rotterdam (NL)

(72) Inventor: Hans Maarten Stokking, Wateringen (NL)

(21) Appl. No.: 19/159,945

(22) PCT Filed: Mar. 20, 2024
(86) PCT No.: PCT/EP2024/057408

§ 371 Date: Aug. 26, 2025

(30) Foreign Application Priority Data
Mar. 22, 2023 (EP) 23163513.7

(51) Int. Cl. G06T 19/00; G06V 10/74

(52) U.S. Cl. CPC G06T 19/006; G06V 10/761; G06V 2201/07

(57) ABSTRACT

A device may be provided for augmenting a scene by overlaying graphical elements over the scene. The device may make use of anchor points to determine where to overlay the graphical elements over the scene. A system may be provided which may provide anchor point data of one or more anchor points to the device. The device may use a camera to acquire camera image(s) of the scene, detect feature points in the camera image(s), match the detected feature points to reference feature points of the anchor points, and in case of a match, select a respective anchor point for use in the augmentation. The device may further generate and provide update data back to the system. The update data may be indicative of a difference between the detected feature points and reference feature points of the selected anchor point. This way, the anchor point data may be updated based on the update data, e.g., to account for changes in the physical environment of the scene or changes in the capture.

### TECHNICAL FIELD

The invention relates to a device and computer-implemented method for augmenting a scene by overlaying graphical elements over the scene. The invention further relates to a system and computer-implemented method for providing anchor point data to the device for use in augmenting the scene. The invention further relates to a computer-readable medium comprising data for causing a processor system to perform the computer-implemented method.

### BACKGROUND

In Augmented Reality (AR) or Mixed Reality (MR), graphical elements may be combined with the physical world perceived by a viewer so as to augment the physical world for the viewer. For example, a head-worn AR or MR device may visually pass-through the external environment to a viewer, for example via a transparent or semi-transparent portion of the device, and may be configured to render one or more graphical elements and display them in such a way that they are overlaid, mixed, blended or in any other way visually combined with the external environment from the perception of the viewer, with such visual combination also being simply referred to as an ‘overlay’ as the graphical elements may appear to the viewer to be overlaid over the scene in front of the viewer. Thereby, the outside world may be augmented with digital content, such as informative content (e.g., navigation directions, descriptive text, or videos) or entertainment (e.g., game characters), etc. Such graphical elements may also be overlaid over a video-based representation of the physical world. For example, a head-worn AR/MR device or a hand-held smartphone device may comprise a forward-facing camera and may record and display the recorded video in (near) real-time to a viewer while augmenting the video with one or more graphical elements.

To be able to place graphical elements at the correct place relative to the physical scene in front of the viewer, a device, such as an AR/MR headset or a capable smartphone, may need to know its location and orientation with respect to the scene. This location and orientation may be determined by the device by analysing camera images acquired of the scene. For example, the device may detect feature points in the camera images, with a feature point being a point where a particular feature is detected. The features may typically include edges or corners detected on physical objects. Various types of feature points and various types of feature point detection techniques are known per se. For example, reference [1] describes feature points and feature point detection with so-called binary robust invariant scalable keypoints (BRISK) and also discusses various other techniques.

When overlaying graphical elements over the scene, so-called anchor points may be used as an intermediate between the feature points and the graphical elements to be overlaid. Such an anchor point may be defined at least in part as a coordinate in a 3D coordinate system and in spatial relation to a set of reference feature points. These reference feature points may be defined by indicating the type of feature point, e.g., whether it is a corner, an isolated point, etc. or by using a descriptor such as those used in feature point detection techniques such as BRISK, and may likewise be provided at least in part in form of coordinates in the 3D coordinate system. If a device detects feature points in a camera image of the scene which match the reference feature points of a given anchor point, or at least to a sufficient degree, the anchor point can be placed in the scene, which placement refers to the position and orientation of the anchor point in the scene being now known, which in turn allows graphical elements to be overlaid over the scene in relation to the anchor point.

It is known to enable devices to download anchor points, e.g., from an online database. For example, Google offers augmented reality services which use so-called cloud anchors [2], and Microsoft offers augmented reality services which use so-called spatial anchors [3]. To be able to download relevant anchor points, the device may determine its coarse location, e.g., using GPS and/or Wi-Fi localisation, and then download data of anchor points in proximity of the device. This way, the device may specifically match detected feature points to the reference feature points of those anchor points which may be expected to be at or near the device's current location.

A problem of the use of anchor points is that changes in the appearance of the scene, e.g., due to changes in lighting, objects appearing or disappearing from the scene, etc., may lead to changes in the detected feature points, e.g., in number, position, etc., This may lead to a lesser match or even mismatch between the detected feature points and the reference feature points of the anchor point. In turn, this may cause inaccuracies when placing, or may even prevent placing, an anchor point.

### REFERENCES

[1] Leutenegger, S., Chli, M., & Siegwart, R. Y. (2011 November). BRISK: Binary robust invariant scalable keypoints. In 2011 International conference on computer vision (pp. 2548-2555). IEEE.
[2] https://developers.google.com/ar/develop/cloud-anchors
[3] https://azure.microsoft.com/en-us/products/spatial-anchors/
[4] Andreas Jakl, Basics of AR: SLAM-Simultaneous Localization and Mapping, 2018 https://www.andreasjakl.com/basics-of-ar-slam-simultaneous-localization-and-mapping/
[5] Cadena, C., Carlone, L., Carrillo, H., Latif, Y., Scaramuzza, D., Neira, J., . . . & Leonard, J. J. (2016). Past, present, and future of simultaneous localization and mapping: Toward the robust-perception age. IEEE Transactions on robotics, 32(6), 1309-1332

### SUMMARY

It may be desirable to enable devices to place anchor points more reliably in the scene even after changes in the appearance of the scene.

In accordance with a first aspect of the invention, a device is provided for augmenting a scene by overlaying graphical elements over the scene. The device may comprise:
a database interface to a database, wherein the database may comprise anchor point data of anchor points for use in scene augmentation, wherein the anchor point data of a respective anchor point may define the anchor point at least in part as a coordinate in a coordinate system and in spatial relationship to a set of reference feature points which may be defined in the anchor point data and may be listed as further coordinates in the coordinate system;
a camera interface to a camera to acquire one or more camera images of a scene;
a processor subsystem which may be configured to:
   via the database interface, obtain anchor point data of anchor points;
   detect feature points from the one or more camera images to obtain detected feature points and coordinates of the detected feature points;
   match the detected feature points to the set of reference feature points of one or more of the anchor points to obtain one or more quantifications of match quality, and if the match quality between a set of detected feature points and the set of reference feature points of an anchor point satisfies a match quality acceptance criterion, select the anchor point to augment the scene;
wherein the processor subsystem may be further configured to provide update data back via the database interface, wherein the update data is indicative of a difference between the set of detected feature points and the set of reference feature points of said selected anchor point.

In accordance with a further aspect of the invention, a computer-implemented method may be provided for augmenting a scene by overlaying graphical elements over the scene. The method may comprise:
accessing a database, wherein the database may comprise anchor point data of anchor points for use in scene augmentation, wherein the anchor point data of a respective anchor point may define the anchor point at least in part as a coordinate in a coordinate system and in spatial relationship to a set of reference feature points which may be defined in the anchor point data and may be listed as further coordinates in the coordinate system;
from the database, obtaining anchor point data of anchor points;
using a camera, acquiring one or more camera images of a scene;
detecting feature points from the one or more camera images to obtain detected feature points and coordinates of the detected feature points;
matching the detected feature points to the set of reference feature points of one or more of the anchor points to obtain one or more quantifications of match quality, and if the match quality between a set of detected feature points and the set of reference feature points of an anchor point satisfies a match quality acceptance criterion, selecting the anchor point to augment the scene; and
providing update data back via the database interface, wherein the update data is indicative of a difference between the set of detected feature points and the set of reference feature points of said selected anchor point.

In accordance with a further aspect of the invention, a system may be provided for providing anchor point data to a device which may be configured to augment a scene by overlaying graphical elements over the scene. The system may comprise:
a database interface to a database, wherein the database may comprise anchor point data of anchor points for use in scene augmentation, wherein the anchor point data of a respective anchor point may define the anchor point at least in part as a coordinate in a coordinate system and in spatial relationship to a set of reference feature points which may be defined in the anchor point data and may be listed as further coordinates in the coordinate system;
a network interface;
a processor subsystem which may be configured to, via the network interface:
   send anchor point data of anchor points to the device to enable the device to select an anchor point to augment a scene by detecting feature points from the one or more camera images to obtain detected feature points and coordinates of the detected feature points and by selecting an anchor point from the anchor points based on a match quality between a set of detected feature points and a set of reference feature points of the anchor point;
   receive update data from the device, wherein the update data may be indicative of a difference between the set of detected feature points and the set of reference feature points of said selected anchor point;
   based on the update data, update the anchor point data of the selected anchor point in the database.

In accordance with a further aspect of the invention, a computer-implemented method may be provided for providing anchor point data to a device which may be configured to augment a scene by overlaying graphical elements over the scene. The method may comprise:
accessing a database, wherein the database may comprise anchor point data of anchor points for use in scene augmentation, wherein the anchor point data of a respective anchor point may define the anchor point at least in part as a coordinate in a coordinate system and in spatial relationship to a set of reference feature points which may be defined in the anchor point data and may be listed as further coordinates in the coordinate system;
sending anchor point data of anchor points to the device to enable the device to select an anchor point to augment a scene by detecting feature points from the one or more camera images to obtain detected feature points and coordinates of the detected feature points and by selecting an anchor point from the anchor points based on a match quality between a set of detected feature points and a set of reference feature points of the anchor point;
receiving update data from the device, wherein the update data may be indicative of a difference between the set of detected feature points and the set of reference feature points of said selected anchor point;
based on the update data, updating the anchor point data of the selected anchor point in the database.

In accordance with a further aspect of the invention, a transitory or non-transitory computer-readable medium is provided comprising data representing a computer program, the computer program comprising instructions for causing a processor system to perform any one or more methods described in this specification.

The above measures may involve a device augmenting a scene by overlaying graphical elements over the scene. As already elucidated in the background section, such augmentation may be within the context of augmented reality (AR) or mixed reality (MR), and may involve overlaying the graphical elements directly over the scene, e.g., via a transparent display or via projection, or by overlaying the graphical elements over a recording of the scene which is rendered in real-time or near real-time to a viewer. The graphical elements may be graphical primitives, such as lines, polygons, etc., but also bitmaps, meshes, point clouds or any other graphical elements. The graphical elements may together represent one or more graphical objects, such as a 3D computer-graphics based object, a video-based object, a text-based object, etc.

The device may be configured to make use of an anchor point to determine at which position(s) to overlay the graphical elements over the scene. Here, the term ‘scene’ may refer to a part of the physical environment which is visible to the camera of the device and which may be augmented by the device. Such an anchor point may be defined in spatial relation to a set of feature points, meaning that the position and optionally also the orientation of the anchor point may be defined in spatial relation to the positions of the feature points. The feature points may also be referred to as ‘reference’ feature points as they may be provided to the device as a reference for the placement of the anchor point. Such reference feature points may at some point in time have been determined in the scene, for example manually and/or automatically by feature point detection. The data of an anchor point, which is elsewhere also referred to as ‘anchor point data’, may identify and characterize the reference feature points. This may involve providing a coordinate and typically, but not necessarily, a descriptor for each reference feature point. This descriptor may act as a fingerprint for the feature point and may be used to match a detected feature point to the reference feature point. It is noted that if descriptors are not used, a set (which may be a subset) of detected feature points may also be matched to a set (which may be a subset) of reference feature points based on similarity in topology. A reference feature point's coordinate may be defined in a coordinate system, typically a 3D coordinate system. The anchor point data may further define the position and optionally the orientation of the anchor point itself in the same coordinate system.

The device may detect feature points in camera images acquired by the device. This may involve detecting features in the camera images to determine their position (at which point a feature may be referred to as a ‘feature point’) and typically, but not necessarily, generating a descriptor for each detected feature point. The device may detect feature points in successive camera images and track the feature points across the camera images. In addition, the device may track the movement and/or rotation of the camera over time, which may allow the device to generate a feature map containing the feature points. In some examples, the feature map generation may also use additional information besides the visual information obtained from the camera images. For example, if the camera is a built-in camera of the device, the device may use one or more gyroscopes and/or one or more accelerometers to track the movement and/or rotation. Typically, such a feature map may be, or comprise, a 3D coordinate system containing the detected feature points.

To be able to place the anchor point in the scene, the device may match the set of reference feature points from the anchor point data to the detected feature points to determine whether there exists a set of detected feature points which matches the set of reference feature points to a sufficient degree. Such a match may be evaluated numerically and may comprise evaluating a positional match, meaning that relative positions of the set of reference feature points as defined in the anchor point data may be matched to the relative positions the set of detected feature points. In other words, the topology of the set of reference feature points may be required to match the topology of a set of detected reference feature points to a sufficient degree, typically after some transformation(s) to convert the positions of the detected feature points into coordinates in the coordinate system used by the anchor point data or vice versa.

In addition, but optionally, the match may be evaluated by evaluating a correspondence in descriptor between individual feature points. For example, a difference may be determined between the descriptor of a reference feature point and a detected feature point, e.g., in form of a mean squared error (MSE), and the magnitude of the difference may indicate how well both feature points match, with a difference of zero typically indicating a perfect match. The device may thus determine whether there exists a set of detected feature points which matches the set of reference feature points to a sufficient degree in terms of relative positions and optionally in terms of descriptors. This ‘sufficient degree’ may for example be determined by obtaining a numerical quantification of the match quality and comparing the numerical quantification against a threshold, and if a result of the comparison is positive, considering the particular set of detected feature points to represent the set of reference feature points of the anchor point. The anchor point may then be placed in the scene based on the positions of the particular set of detected feature points, for example in a manner known per se from known augmentation techniques which use anchor points, such as the aforementioned cloud anchors [1] and spatial anchors [2].

In further accordance with the above measures, the device may obtain anchor point data of one or more anchor points and determine whether a set of detected feature points is representative for one of the anchor points. For example, the device may obtain the anchor point data of anchor points which are in proximity of the device. Once an anchor point has been detected, meaning that once a sufficient match between a set of reference feature points and a set of detected feature points has been determined, the device may determine a difference between the set of detected feature points and the set of reference feature points. It will be appreciated that there may be a difference even if a match has been found since the match may be imperfect. This difference may lie in various aspects. For example, if a reference feature point is matched to a detected feature point, there may still be a difference in relative position, in that the detected feature point may have a relative position to the other detected feature points which may not match the relative position of the reference feature point relative to the other reference feature points. Another example is that the descriptor of a detected feature point may not fully match the descriptor of a reference feature point. Yet another example is that one of the reference feature points may not be matched to a detected feature point, in that there simply may not be a detected feature point which may represent the particular reference feature point or in that the match quality may be insufficient. Yet another example is that one of the detected feature points may not be matched to a reference feature point, in that there simply may not be a reference feature point which may represent a particular detected feature point or in that the match quality may be insufficient. Having determined a difference between the set of detected feature points and the set of reference feature points, the device may generate update data which may be indicative of this difference, for example by explicitly identifying the difference, by identifying a type of the difference, by identifying a magnitude of the difference, etc. Having generated the update data, the device may return the update data via the database interface, for example by uploading the update data via the database interface. This way, the update data may be provided to a same entity via which anchor points have been retrieved. This entity may for example be the database itself or a server managing or otherwise operating the database.

It is noted that, alternatively, instead of the device or method itself determining a difference between the set of detected feature points and the set of reference feature points of the selected anchor point, the device and method may rather include the detected feature points, or a subset thereof, in the update data. This may allow the difference to be determined by the entity receiving the update data and to update the anchor point data based on the difference. It is further noted that references to “the” difference do not imply that the update data is indicative of all differences between the set of detected feature points and the set of reference feature points of said selected anchor point. While this may be the case, the update data may typically be generated to be indicative of a subset, e.g., one or more, of all differences.

By providing such update data back via the database interface, the anchor point data of the particular anchor point may be updated based on the update data. This may be advantageous since the reference feature points of the anchor point data in the database may have been determined in the past, e.g., days, weeks, months or years ago, and may not reflect a current appearance of the scene. Namely, there may be changes in the appearance of the scene, e.g., due to changes in lighting, objects appearing or disappearing from the scene, etc. Such changes may lead to changes in the detected feature points, e.g., in number, relative position, descriptor, etc. This may lead to a lesser match or even mismatch between the detected feature points and the reference feature points of the anchor point. In turn, this may cause inaccuracies when placing, or may even prevent placing, an anchor point. The update data may thus be used to update the anchor point data of the anchor point in the database. For example, the anchor point data may be directly adjusted to account for the difference, in that a reference feature point may be deleted or marked as deleted or hidden, in that a reference feature point may be added based on a detected feature point, in that a coordinate or a descriptor of a reference feature point may be adjusted, etc. Another example is that the update data may be accrued, e.g., over time and/or over several devices, to gather statistics regarding the differences, which enables the anchor point data to be updated only when statistically meaningful differences start to appear or when changes appear more stable over time or when changes are deemed to be more certain due to a number of devices reporting the same or similar changes. It will be appreciated that in some examples, the update data may also be used to determine when to update the anchor point data, without the update data itself being used in the update of the anchor point data. For example, the update data may selectively trigger a manual update of the anchor point data if the update data indicates significant changes between the set of reference feature points and the set of detected feature points.

The following embodiments may be described with reference to the device and the computer-implemented method for augmenting a scene by overlaying graphical elements over the scene, but may equally apply to the system and the computer-implemented method for providing anchor point data to the device.

In an embodiment, the processor subsystem may be configured to identify, in the update data, which one or more reference feature points are not matched to the set of detected feature points. The anchor point data may contain reference feature points which could not be matched by the device to detected feature points. This may be due to the feature represented by the reference feature point having disappeared from the scene, or being currently occluded, or the appearance of the feature point having changed so much that the device cannot match the feature point to the respective reference feature point. By reporting which reference feature point(s) could not be matched to detected feature points, these reference feature point(s) may be removed from the anchor point data, marked as occluded, their descriptor may be adjusted, their position may be changed etc., for example directly in response to the receipt of the update data or after receiving similar updates from other devices.

In an embodiment, the processor subsystem may be configured to identify, in the update data, which one or more detected feature points are not matched to the set of reference feature points. The device may detect feature points which could not be matched by the device to the selected set of reference feature points. These detected feature points may nevertheless be relevant for an anchor point, for example by being part of the same object or part of the scene to which the anchor point pertains. The omission of an additionally detected feature point from a selected set of reference feature points may be due to the additionally detected feature point having recently appeared in the scene, or having been de-occluded, or the appearance of the feature point having changed so much that the device cannot match the feature point to any of the reference feature points. By reporting which detected feature point(s) could not be matched to the selected set of reference feature points, these detected feature point(s) may be added to the anchor point data, marked as de-occluded, their descriptor may be adjusted, their position may be changed etc., for example directly in response to the receipt of the update data or after receiving similar updates from other devices.

In an embodiment, the processor subsystem may be configured to identify a feature point in the update data by providing a coordinate of the feature point in the coordinate system. If the update data refers to a feature point, the feature point may be identified in the update data. For that purpose, an(y) identifier of the feature point may be included in the updated data. A well-suited identifier may be the coordinate of the feature point in the coordinate system. If the feature point is a reference feature point which is already listed in the update data, the coordinate may uniquely identify the reference feature point. If the feature point is an additionally detected feature point, meaning that the feature point has no corresponding reference feature point in the anchor point data or at least such a match could not be established, the coordinate may uniquely identify the additionally detected feature point and enable the additionally detected feature point to be added as a reference feature point later on. Alternatively, the respective feature point may be identified by another type of identifier, such as a unique random string or a simple sequential counter. When a reference feature point could not be detected or was found to be changed, such an identifier may be used to identify the reference feature point. It is noted that in case of a newly found feature point, a separate identifier besides the coordinate may not be needed.

In an embodiment, the anchor point data may comprise a reference descriptor for a respective reference feature point, wherein the reference descriptor may characterize an appearance of the respective feature point, wherein the processor subsystem may be configured to generate a descriptor for a respective detected feature point to obtain a generated descriptor and to determine the match quality between the respective reference feature point and the respective detected feature point at least in part based on a correspondence between the reference descriptor and the generated descriptor. The match quality between a set of detected feature points and the set of reference feature points of an anchor point may thus be determined based on the aforementioned positional match as well as based on a correspondence in descriptors of detected and reference feature points. Such descriptors may be generated for the detected feature points using a feature detector, while a same type of descriptor may be included for the reference feature points in the anchor point data, possibly in some kind of encoded format.

In an embodiment, the processor subsystem may be configured to identify, in the update data, if the correspondence does not satisfy a correspondence criterion or if the respective detected feature point is detected after, or only after re-generating the generated descriptor using a different configuration of a feature detector. The correspondence between the descriptor of a particular detected feature point and a particular reference feature point may be deemed insufficient, namely by the correspondence not satisfying a correspondence criterion, for example in form of a MSE exceeding a threshold. Nevertheless, the detected feature point may still represent the reference feature point, as the lack of correspondence may be due to a change in appearance of the feature point, while possibly the position of the feature point may have remained largely unchanged. In such cases, it may be desirable to update the reference descriptor, e.g., to account for the change of appearance of the feature point. By indicating in the update data that the correspondence criterion is not satisfied, and optionally by including the generated descriptor, the reference descriptor may be updated accordingly. In some examples, the device may itself have adjusted the configuration of the feature detector so as to be able to obtain an adjusted descriptor which has a sufficient correspondence to the reference descriptor. In such examples, the update data may be generated by the processor subsystem to indicate that the respective detected feature point is detected after, or only after re-generating the descriptor of the feature point using a different configuration of the feature detector. This way of updating the anchor point data, namely by providing a new descriptor, may also be used when the anchor point technique is to be changed from the use of one type of descriptor to the use of another type of descriptor. In such a case, the device may be provided with new descriptors, preferably for all reference feature points.

In an embodiment, the processor subsystem may be configured to indicate, in the update data, the different configuration of the feature detector and/or said re-generated descriptor. In such examples, the device may include the adjusted configuration and/or the adjusted descriptor in the update data. This may avoid a need to re-generate the descriptor at the database side, which may otherwise require more information, such as the acquired camera image(s), to be able to successfully re-generate the descriptor so as to enable the detected feature point to be matched.

In an embodiment, the processor subsystem may be configured to determine, if a reference feature point is not matched to the set of detected feature points in at least one of the one or more camera images, whether a feature corresponding to the reference feature point is occluded in the at least one of the one or more camera images, and if so, may indicate in the update data that the feature is occluded, wherein the processor subsystem may be configured to determine said occlusion by detecting the feature in one or more other camera images of the scene which one or more other camera images show the scene from a different position and/or orientation.

In an embodiment, the processor subsystem may be configured to include, in the update data, metadata which characterizes the scene or said acquisition of the one or more camera images of the scene, wherein the metadata may indicate for example one or more of: a time of day of the acquisition of the one or more camera images, a date of the acquisition of the one or more camera images, a light or brightness level detected by the camera, a light direction detected by the camera, a camera image from the one or more camera images, a reduced-size representation of the camera image, an orientation of the camera with respect to the scene, a lens characteristic of the camera used to capture the camera image, a contrast level in the camera image, a dynamic range of the camera image, etc. When there is a change in appearance of the scene resulting in a difference appearing between the set of detected feature points and the set of reference feature points of an anchor point, the context of the acquisition of the scene may be of interest, for example to be able to determine whether the change in appearance is a temporary change or a (semi-) permanent change. For example, in the former case, it may be of interest whether the change is expected to periodically occur and periodically not to occur, which may be the case if the change in appearance is due to changes in lighting (e.g., sunlight during the day and artificial lighting at night, daylight with open sky or clouds or rain) or due to seasonal changes (e.g., fallen snow). The abovementioned metadata may be indicative of this context; by including said metadata in the update data, the anchor point data may be updated in a more reliable manner, e.g., by choosing not to update in case of temporary changes, by adding an additional layer to the anchor point data to reflect a changing appearance of the scene which is expected to periodically occur, by choosing to update the anchor point data in case of (semi-)permanent changes, etc.

In an embodiment, the database interface may be a network interface and the database may be a network-accessible database, for example hosted by a network server or as a cloud database. In some embodiments, the device may retrieve the anchor point data from a network-accessible database. The database may thus be hosted remotely from the device. In such cases, it may be especially valuable to return update data as the database or the entity operating the database may be remote from the scene. The latter entity may elsewhere be referred to as an ‘anchor point system’.

In an embodiment, the data interface may be an internal interface of the device and the database may be an internal database of the device. In such embodiments, the update data may be used by the device itself, e.g., by another process or component, to update the anchor point data. Alternatively, if the internal database of the device is used as an offline buffer for the anchor point data of a remote database, the update data may be buffered in the internal database and uploaded to the remote database once the device has a data connection to the remote database.

In an embodiment, the processor subsystem is configured to obtain updated anchor point data via the database interface, wherein the updated anchor point data is updated as described elsewhere in this specification, and to use the updated anchor point data to match the detected feature points to a set of reference feature points so as to be able to select an anchor point for use in augmenting the scene.

The following embodiments may be described with reference to the system and the computer-implemented method for providing anchor point data to a device which is configured to augment a scene by overlaying graphical elements over the scene, but may equally apply to the device and the computer-implemented method for augmenting a scene by overlaying graphical elements over the scene.

In an embodiment, the processor subsystem may be configured to, if the update data identifies one or more detected feature points which are not matched by the device to the set of reference feature points, update the anchor point data of the selected anchor point by adding the one or more detected feature points as one or more new reference feature points to the anchor data. The device may detect feature points which could not be matched by the device to the selected set of reference feature points. These detected feature points may nevertheless be relevant for an anchor point, for example by being part of the same object or part of the scene to which the anchor point pertains. The omission of an additionally detected feature point from a selected set of reference feature points may be due to the additionally detected feature point having recently appeared in the scene, or having been de-occluded, or the appearance of the feature point having changed so much that the device cannot match the feature point to any of the reference feature points. By receiving update data from the device identifying which detected feature point(s) could not be matched to the selected set of reference feature points, these detected feature point(s) may be added to the anchor point data, for example directly in response to the receipt of the update data or after receiving a sufficient number of similar updates from other devices.

In an embodiment, the processor subsystem may be configured to add the one or more new reference feature points in a separate data structure to the anchor data, which separate data structure is separate from a data structure storing the set of reference feature points. By adding the one or more new reference feature points in a separate data structure to the anchor data, these reference feature points may be kept separate from the original reference feature points, which may be advantageous for various purposes. For example, the separate data structure may be used to store the new reference feature points which are not yet validated as being reliable; once a sufficient number of similar updates from other devices have been received, a new reference feature point may be moved to the data structure storing the set of original reference feature points. Another example is that the separate data structure may be used to perpetually distinguish original reference feature point from new reference feature points which were added via the update data, e.g., for data integrity or security purposes. Yet another example is that the new data structure may be used to store additional feature points which were detected due to a temporary change in appearance of the scene. In a specific example, the new data structure may be considered as an additional layer which can be, but does not have to be, used by the device. For example, a device may try to place an anchor point by using a base layer containing the set of original reference feature points, and only if this base layer is deemed not to yield a sufficient match, make use of one or more additional layers.

In general, the data structure storing the set of reference feature points may be considered a main data structure and the separate data structure as an auxiliary or additional data structure. In some embodiments, the data structures may be considered as layers, e.g., as a main layer and an additional layer, which additional layer may be combined with the main layer, for example by decision of the device or the database.

In an embodiment, the processor subsystem may be configured to, if the update data identifies one or more reference feature points which are not matched by the device to the set of detected feature points, update the anchor point data of the selected anchor point by removing, marking, or adjusting a property of the one or more reference feature points in the anchor point data. The anchor point data may contain reference feature points which could not be matched by the device to detected feature points. This may be due to the feature represented by the reference feature point having disappeared from the scene, or being currently occluded, or the appearance of the feature point having changed so much that the device cannot match the feature point to the respective reference feature point. By receiving update data from the device identifying which reference feature point(s) could not be matched to detected feature points, these reference feature point(s) may be removed from the anchor point data, marked as occluded, their descriptor may be adjusted, their position may be changed etc. This change may for example be directly in response to the receipt of the update data or after receiving a sufficient number of similar updates from other devices.

In an embodiment, the processor subsystem may be configured to receive update data from a plurality of devices and to perform an analysis of the update data to determine whether to effect a change, and/or which change to effect, of the anchor point data based on the update data. The analysis may for example be a statistical analysis. In a specific example, a statistical analysis may be applied to the coordinates of a detected feature point as reported by several devices to obtain a mean or majority coordinate which may then be added to the anchor point data. An additional variability parameter may be added to, for example, indicate a standard deviation in one or more directions of the reported coordinate. Such a variable feature point may still be useful to establish a match to an anchor point, for example if the feature point is easy to detect based on its descriptor, whereas other feature points may be more difficult to detect but can then be detected to establish more precise coordinates. Another example is that the statistical analysis may be applied to the update data from several devices to determine whether a change is temporary or permanent. In some examples, the analysis may be based on machine learning. For example, the processor subsystem may make use of a machine learned model which is trained on training examples of update data to determine whether to effect the change and/or which change to effect.

In an embodiment, the update data may comprise metadata which may characterize the scene or said acquisition of the one or more camera images of the scene, and wherein the processor subsystem may be configured to perform the analysis of the update data by analysing the metadata to determine whether to effect a change and/or which change to effect. The metadata may be of a type as described elsewhere in this specification. When there is a change in appearance of the scene which resulted in update data being sent by the device, the context of the acquisition of the scene may be of interest, for example to be able to determine whether the change in appearance is a temporary change or a (semi-)permanent change. For example, in the former case, it may be of interest whether the change is expected to periodically manifest itself, which may be the case if the change in appearance is due to changes in lighting (e.g., sunlight during the day and artificial lighting at night) or due to seasonal changes (e.g., fallen snow). The abovementioned metadata may be indicative of this context; by including said metadata in the update data and by analysing the metadata, e.g., using a statical analysis and/or using machine learning, the anchor point data may be updated in a more reliable manner, e.g., by choosing not to update in case of temporary changes, by adding an additional layer to the anchor point data to reflect a changing appearance of the scene which is expected to periodically occur, by choosing to update the anchor point data in case of (semi-)permanent changes, etc.

It will be appreciated by those skilled in the art that two or more of the above-mentioned embodiments, implementations, and/or aspects of the invention may be combined in any way deemed useful.

Modifications and variations of any one of the systems or devices, computer-implemented methods, and/or computer programs, which correspond to the described modifications and variations of another one of these systems or devices, computer-implemented methods, and/or computer programs, or vice versa, may be carried out by a person skilled in the art on the basis of the present description.

### BRIEF DESCRIPTION OF THE DRAWINGS

These and other aspects of the invention are apparent from and will be elucidated with reference to the embodiments described hereinafter. In the drawings,

FIG. 1 shows a scene in form of a room with a window, painting, and a door;

FIG. 2 shows feature points which may be detected in camera image(s) of the scene, with the feature points being shown overlaid over the scene;

FIG. 3 shows the feature points having been assigned coordinates in a 3D coordinate system;

FIG. 4 illustrates a change in the appearance of the scene, with the room now containing a sofa which partially occludes the painting;

FIG. 5 illustrates another change in the appearance of the scene, with the painting having been removed;

FIG. 6 shows components, subsystems, and software-based functions of an augmented reality device which is configured to augment a scene by detecting feature points in the scene and by matching the feature points to one or more anchor points;

FIG. 7 shows a method of updating anchor point data;

FIG. 8 illustrates metadata which may be returned by the device, with the metadata indicating a visibility of feature points as a function of the Euler angle α;

FIG. 9 illustrates metadata which may be returned by the device, with the metadata indicating a visibility of feature points in form of a feature point visibility cone;

FIG. 10 shows a device configured to augment a scene;

FIG. 11 shows a system configured to provide anchor point data to a device;

FIG. 12 shows a non-transitory computer-readable medium comprising data;

FIG. 13 shows an exemplary data processing system.

It should be noted that items which have the same reference numbers in different figures, have the same structural features and the same functions, or are the same signals. Where the function and/or structure of such an item has been explained, there is no necessity for repeated explanation thereof in the detailed description.

Reference signs list
The following list of references and abbreviations is provided
for facilitating the interpretation of the drawings and shall
not be construed as limiting the claims.

| | |
|---|---|
| 10 | network |
| 20 | scene |
| 30 | object (painting) |
| 32 | object (sofa) |
| 40 | feature point |
| 42 | additionally detected feature points |
| 50 | coordinate system |
| 60 | coordinates of feature point in coordinate system |
| 70 | visualization of metadata indicating feature point visibility |
| 80 | reference coordinate system |
| 90 | cone indicating feature point visibility |
| 100 | device for augmenting scene |
| 110 | network interface |
| 120 | camera interface |
| 130 | camera |
| 132 | depth camera |
| 140 | processor subsystem |
| 142 | localisation subsystem |
| 144 | anchor point detection function |
| 146 | data association function |
| 148 | feature extraction function |
| 150 | data storage |
| 152 | local anchor point data database |
| 160 | inertial measurement unit |
| 170 | display interface |
| 180 | display |
| 200 | system for providing anchor points |
| 210 | database interface |
| 220 | anchor point data database |
| 222 | private anchor point data database |
| 224 | public anchor point data database |
| 230 | network interface |
| 240 | processor subsystem |
| 300 | method to update anchor point data |
| 310 | retrieve anchor point data |
| 320 | analyse scene to detect anchor point |
| 330 | determine update to anchor point data |
| 340 | provide update to anchor point system |
| 350 | update anchor point data |
| 400 | non-transitory computer-readable medium |
| 410 | stored data |
| 1000 | exemplary data processing system |
| 1002 | processor |
| 1004 | memory element |
| 1006 | system bus |
| 1008 | local memory |
| 1010 | bulk storage device |
| 1012 | input device |
| 1014 | output device |
| 1016 | network adapter |
| 1018 | application |

### DESCRIPTION OF EMBODIMENTS

The following embodiments are described in the context of an augmented reality device, referring to a device which is configured to augment reality, but may equally apply to a mixed reality device or in general to any device which is configured to augment a scene by overlaying graphical elements over the scene.

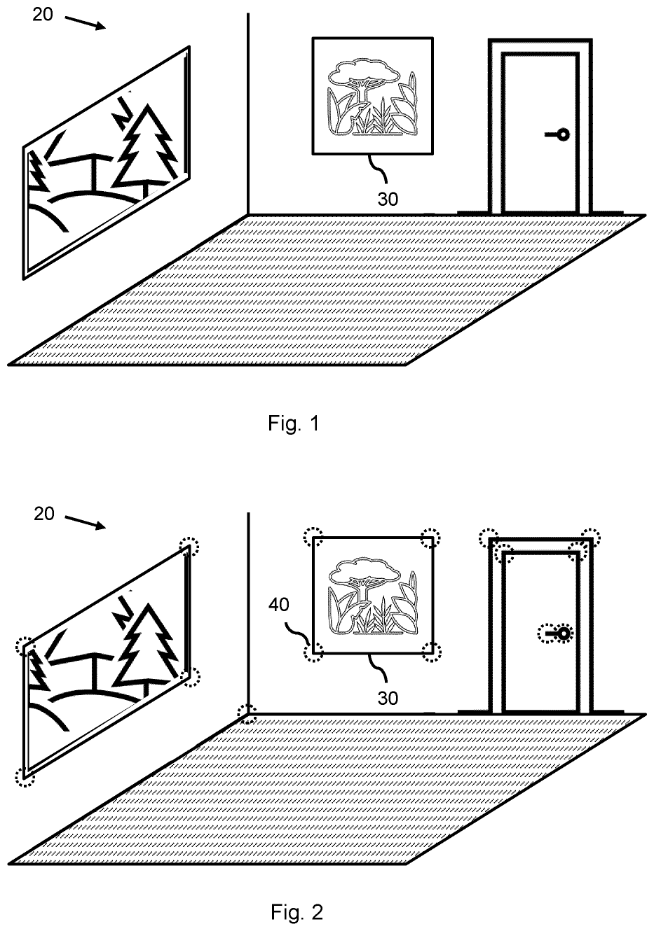

FIG. 1 shows an example of a scene 20, which term may be understood as referring to a part of the physical environment at a particular location, e.g., as may be observed by a viewer or by a camera, and which may be indoor (as the scene shown in FIG. 1) or outdoor or a combination thereof. In the example of FIG. 1, the scene 20 is shown to comprise part of a room which includes a window on the left-side wall and a painting 30 on the rear wall, with the rear wall further including a door. In such a scene, augmented reality may be used to provide contextual information on the painting 30. For example, the room may be part of a museum and the painting 30 may represent a piece of art which is exhibited by the museum in the room. The museum, or another provider, may offer the contextual information on the exhibited art via an augmented reality application for a smartphone or similar device. This application may be used by visitors to the museum. When using the application, visitors may be prompted to point the camera of their device towards the painting 30, with the application then overlaying contextual information over the scene displayed on the display of their smartphone. For example, explanatory text may be shown besides the painting 30, significant features in the painting 30 may be highlighted, alternative versions of the painting may be temporarily overlaid to replace the actual contents of the painting 30, etc.

The aforementioned augmented reality application, and in general any augmented or mixed reality application or device, may detect feature points in camera images acquired by the device. FIG. 2 shows an example of such feature point detection for the scene 20 of FIG. 1, showing some feature points 40 which may be detected by a feature point detection technique. It can be seen that prominent corners of objects, such as corners of the window, corners of the painting 30, and corners of the door are detected as feature points. In addition, FIG. 2 shows that the door handle of the door is detected as a feature point due to the high contrast with its surroundings.

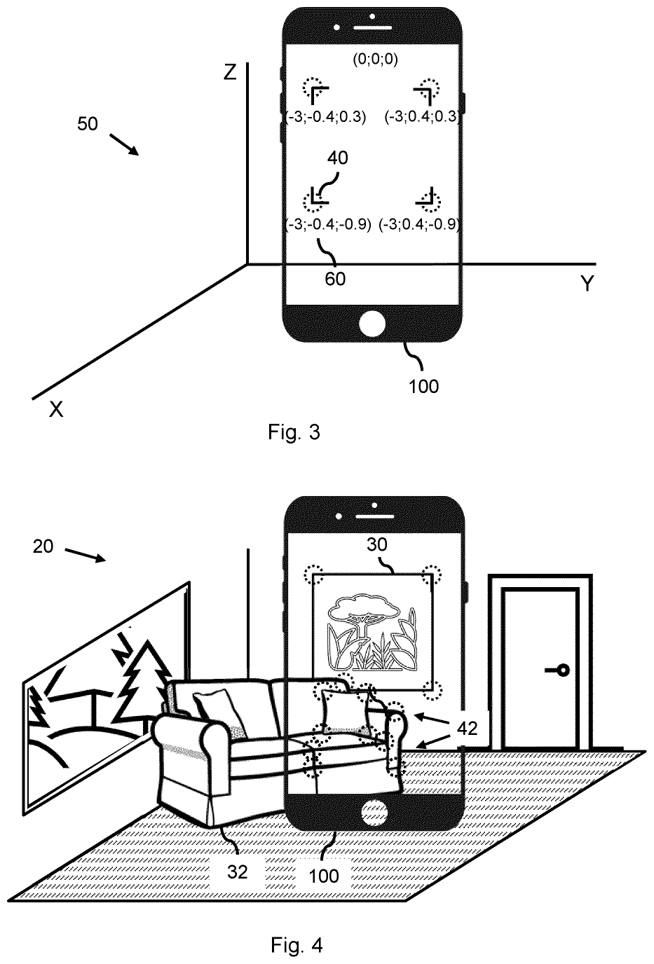

FIG. 3 illustrates an internal functioning of a device 100, e.g., the aforementioned smartphone, by showing the feature points having been assigned coordinates in a 3D coordinate system. This is illustrated in FIG. 3 by the device 100 showing the detected feature points 40 within its current field of view on its display, being in this example the detected feature points 40 of the painting (painting itself not being shown in FIG. 3). These feature points may be assigned coordinates in a three-dimensional coordinate system 50. FIG. 3 shows exemplary coordinates 60 having been assigned. It is noted that during normal operation of an augmented reality application, the coordinates of the detected feature points may not be shown on the display, and typically also not the feature points themselves. The device 100 may be moved by its user and thereby repositioned and/or reoriented with respect to the scene. During that time, new camera images may be acquired by the camera of the device 100. In these new camera images (which in the following may also be referred to as ‘frames’), feature points may be detected. As a result, the feature points 40 of the painting may be detected in several frames and new features point may be detected in newly captured parts of the scene. As is known per se, this may allow the device 100 to determine its 3D position and orientation in relation to the detected feature points and thereby in relation to the scene. This way, the device 100 may build-up a 3D feature point map of its surrounding physical environment. For example, the technique ‘simultaneous location and mapping’ (SLAM) may be used as described in [4] and [5].

As will be further described with reference to FIG. 6, the process of the device determining its 3D position and orientation with respect to its surrounding physical environment, i.e., the scene, may be facilitated by using a depth sensor for 3D localization of feature points and/or by using inertial sensors for tracking the movement of the device. Also, another independent location tracking technique may be used, e.g., using GPS for outdoor or some Wi-Fi or Bluetooth localisation for indoor. It is also known in the art to apply AI techniques to such localisation and mapping.

With continued reference to FIG. 3, it is noted that the location of the detected feature points may be maintained by the device by assigning, and possibly later re-assigning, coordinates to the detected feature points within the coordinate system 50. The assigned coordinates may together represent the aforementioned 3D feature point map (which may elsewhere also simply be referred to as ‘3D feature map’). As the coordinates assigned to the detected feature points may be relative coordinates, e.g., relative to other detected feature points, the choice of origin of the coordinate system may be of lesser importance or even arbitrary. Accordingly, the origin may be chosen by the device 100, for example when the first feature point is detected, in any suitable manner. By way of example, FIG. 3 shows the device having chosen the origin to correspond to the current position of the device shown in FIG. 3.

The 3D feature point map of the environment may allow for the placement of virtual objects, or in general of one or more graphical elements, at a location which may appear to be ‘fixed’ with respect to the scene. Alternatively, or in addition to the use of a 3D feature point map, such graphical elements may be placed within the scene using so-called anchor points as introduced in the background section. Such anchor points may be provided to the device from a database, for example from a cloud database. Each anchor point may be defined as data which defines the anchor point at least in part as a coordinate in a coordinate system and in spatial relationship to a set of reference feature points which are defined in the anchor point data and listed as further coordinates in the coordinate system. The device may match the detected feature points to the set of reference feature points of one or more anchor points to obtain one or more quantifications of match quality, and if the match quality between a set of detected feature points and the set of reference feature points of an anchor point satisfies a match quality acceptance criterion, select the anchor point to augment the scene. It is noted that functionality described in this paragraph may be known per se.

In some embodiments, the anchor point data may, in addition to defining a coordinate of the anchor point in the coordinate system, also define an orientation of the anchor point, for example in form of a 3D vector. In some embodiments, the anchor point data may include a real-world location of the anchor point, e.g., in form of a GPS coordinate or real-world address (for example defined as any one or more of the following elements: street, house number, zip code, city, country, in-building room number, floor number, etc.). The data in the anchor point data may be encoded in various ways, e.g., as an object with header data and further containing an array or list of feature points, which object may then be encoded XML, JSON, ASCII, in binary form, etc. In some embodiments, the anchor point data may, in addition to defining coordinates of the reference feature points in the coordinate system, also provide a descriptor for each or for a subset of the reference feature points. Such a descriptor may also be referred to as a feature point description and may characterize an appearance of a respective feature point. The type of descriptor may depend on the technique which is used for feature detection and may thus be different for, e.g., known feature point detection techniques SIFT, SURF and BRISK. The descriptor may be provided in the anchor point data in an encoded form. In a specific example, the anchor point data may define the reference feature points as an array which contains for each feature point its coordinate, its descriptor and in some cases other metadata characterizing the feature point, which other metadata may be explained elsewhere in this specification. The reference feature points may for example be defined as an object with header data and containing entries for each respective reference feature point, which object may then be encoded XML, JSON, ASCII, in binary form, etc.

It is noted that the coordinate system in which the anchor point and the reference feature points are defined may be the same as used by the device to define detected feature points. However, both coordinate systems may also be different. In the latter case, the device may use a mapping function which maps coordinates from one coordinate system to the other and vice versa to be able to match reference feature points to detected feature points. It is further noted that the device may store detected feature points in a same or similar manner as the reference feature points are stored in the anchor point data, e.g., as a coordinate, a descriptor and in some cases other metadata characterizing the feature point. However, this is not a limitation, in that the detected feature points may also be stored in a different format by the device.

When using anchors points, it may be problematic if the appearance of the scene changes. Namely, changes may lead to changes in detected features points on the device and may lead to a mismatch when comparing the detected feature points with the reference features points from an anchor point. This may lead to inaccuracy in placement of an anchor point, or even an inability to place an anchor point. The changes may include physical changes in the environment, including but not limited to:
A difference in lighting, e.g., day versus night, changing weather influences, changing indoor lighting. As detection of feature points may be based on a visual analysis, changing lighting conditions may affect the detection of feature points.
Addition or removal of objects, e.g., furniture, plants, papers, appliances, decoration, etc. It is noted that an additional object may not only introduce new feature points but may, depending on the point of view of the camera used by the device, also occlude existing feature points which were previously defined for the scene.
For anchor points in an outside environment: changes in natural elements due to changes in seasons, e.g., leaves of trees falling in autumn, snow falling in winter, rain, frost, but also addition or removal of objects such as parked cars, changes in road layouts, building construction or reconstruction, etc.

FIG. 4 illustrates a change in the appearance of the scene 20, as the room now contains a sofa 32 which partially occludes the painting 30. While new feature points 42 of the sofa may be detected, the feature point at the bottom-left corner of the painting 30 may not be detected anymore as this corner is now occluded by the sofa.

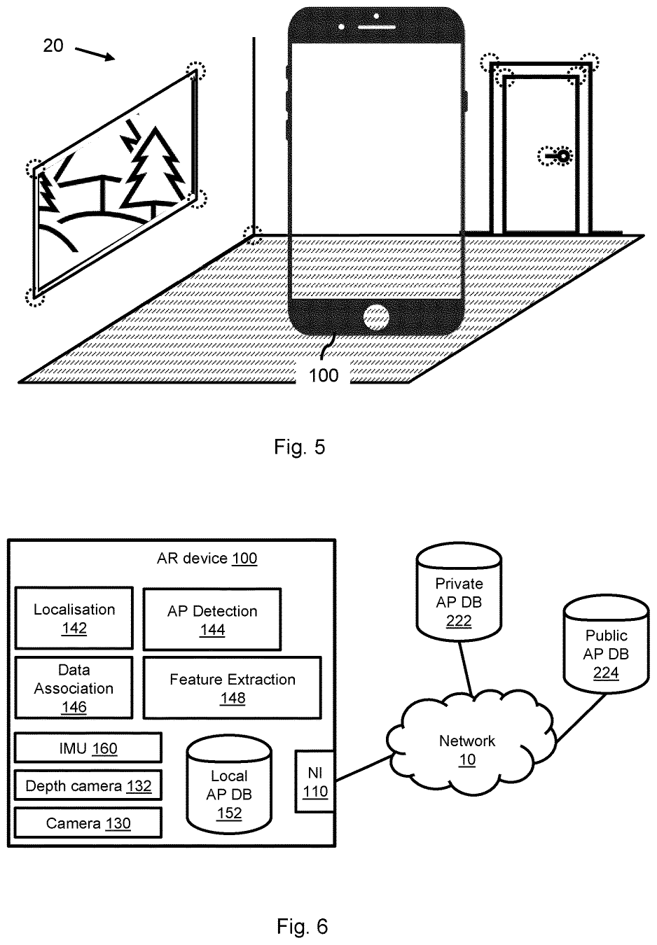

FIG. 5 illustrates another change in the appearance of the scene 20, as the painting has now been removed. As such, the device may not detect the feature points of the painting anymore when detecting feature points in the scene 20.

Other changes in the appearance of the scene may be due to changes in the device itself. Here, the term ‘changes in the device itself’ may refer to differences between the device, or the general technological state of devices, for which the reference feature points were defined and a current device or a current technological state of devices. For example, improvements in camera sensors may cause current devices to be more sensitive in indoor locations where the lighting is relatively poor, which higher sensitivity may also affect the detection of feature points. For example, an existing descriptor may not work well for a significantly more sensitive camera sensor. Other examples include, but are not limited to the spectral range of camera sensors having increased, the camera images being now obtained by image fusion from several camera sensors, the camera images being additionally provided with depth data, a difference in lens distortion, a difference in used focal lengths, smudges on the lens, etc.

To be able to accommodate such changes in the appearance of the scene, the device may determine a difference between the set of detected feature points and the set of reference feature points, and if such a difference exists, generate update data which may be indicative of this difference. The device may then return the update data to the entity which provided the anchor point data to which the update data pertains. Alternatively, the device may generate the update data to include the set of detected feature points, or a subset thereof, to enable the receiving entity to determine the difference. In both cases, the receiving entity may use the update data to update the anchor point data to reflect the changes in the appearance of the scene. Such an update may be in direct response to the update data, or indirectly, e.g., after having received similar update data from other devices or by an analysis indicating that the changes in the appearance of the scene are permanent or at least likely to reappear.

FIG. 6 shows components, subsystems, and software-based functions of a device 100 configured to augment a scene by matching detected feature points to one or more anchor points and to generate update data, for example if a difference is determined between the detected feature points and the reference feature points of the anchor point. The device may here be referred to as an ‘augmented reality’ or in short ‘AR’ device but may in general also be a mixed reality device or any other type of devices configured to augment a scene by overlaying graphical elements over the scene.

The device 100 may comprise one or more of the following components, subsystems, and software-based functions:
Localisation subsystem 124: this subsystem may provide (coarse) localisation of the device which may be used to request the anchor point data of anchor points which are in proximity to the device. Such localisation for the purpose of requesting anchor point data may not need to be very precise and may for example be based on GPS (outdoor), Wi-Fi AP name (indoor) or any other form of localisation.
Sensor(s): the device may have one or more sensors. These sensors may include an image sensor, e.g., as part of a camera 130, to visually capture the physical environment surrounding the device. The device may also use more than one camera, for example to capture more detail or to also capture depth information using a depth camera 132. Other sensors may include movement sensors such as an IMU 160 to assist in tracking detected feature points across captured camera images.
Feature extraction function 148: this function, which may typically be implemented in software, may detect feature points in a camera image.
Data association function 146: this function may optimise the feature point detection process by using information obtained from several camera images. For example, the data association function 146 may enable the tracking of feature points across camera images or to allow so-called loop closure which may ensure that all detected feature points end up in a consistent world model.
Anchor point detection function 144: this function may match detected feature points to the reference feature points provided in the anchor point data.
Anchor points may be stored in a local database 152. This may typically be a temporary storage to store the anchor point data downloaded from a central database. However, in some examples, the anchor point data may be stored (semi-) permanently, e.g., when provided as part of an augmented reality application, for example for a museum where only the anchor points in that museum are relevant.
Network interface 110: a network interface may allow the device 100 to connect to a network, for example to an access network and from there to the internet 10, and may allow the device to download anchor point data, for example from a cloud database. The database from which the anchor point data may be downloaded may be a private database 222, e.g., specific to a certain application or company, but may also be a public database 224, which may store anchor points generated by different applications and companies, or a combination of both types of databases.

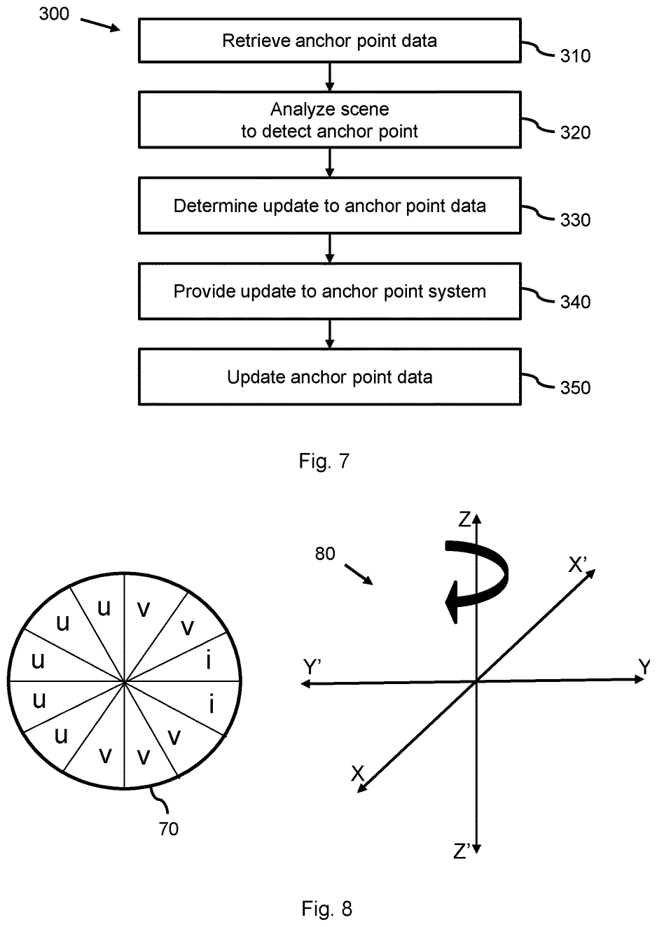

FIG. 7 shows a method 300 of updating the anchor point data. The method is shown to comprise steps performed at or by the device and steps performed at or by an entity which operates the database storing the anchor point data. It will be appreciated that the steps performed at either the device or the aforementioned database operating entity may constitute an individual and separate method.

The method 300 is shown to comprise the following steps:
“Retrieve anchor point data” 310. This step may involve the device retrieving, or otherwise obtaining anchor point data of one or more anchor points from the anchor point system. This may involve the device sending a request message to the entity operating the database, which may for example be a cloud-hosted server or back-end software function. If the retrieval of the anchor point data is initiated by an application running on the device, the application may for example invoke an API call on a library that is implementing an anchor point system. Typically, the anchor point data of several anchor points is received as the device may request the data of anchor points which are in proximity of the coarse geographical location of the device.
“Analyze scene to detect anchor point” 320. This step may involve the device using its camera(s) to visually capture the scene in front of or surrounding the device. For example, the user may move the device around, so that the camera(s) on the device can capture images of its surroundings. The device may detect feature points in these images, which detected feature points may be matched to the information provided by the anchor point data. Once sufficient feature points are matched (e.g., a certain reliability threshold is reached, which reliability threshold may be an example of a match quality acceptance criterion as discussed elsewhere in this specification), the anchor point may be selected for use in augmenting the scene.
“Determine update to anchor point data” 330. This step may involve the device determining a difference between the reference feature points of the selected anchor point and the feature points which are detected in the scene and deemed relevant for the placement of the anchor point. Such a difference may, but does not need to be the result of the device continuing capturing, or have already captured more of the physical environment, in which case the device may continue to compare the anchor point data to newly detected features points in the ongoing capture in order to stabilise the detection of the anchor point, e.g., in terms of spatial location. As part of such ongoing capturing, or as a separate step, the device may determine that there is a difference between the reference feature points of the selected anchor point and the feature points detected in the scene. For example, the device may determine that newly detected feature points are missing in the current anchor point data and are nevertheless relevant for the placement of the anchor point. The device may then generate update data which is indicative of the difference, and which update data may be used to update the anchor point data of the selected anchor point. This step may be performed by the device, but may alternatively be performed by the database or entity operating the database, after step 340.
“Provide update to anchor point system” 340: This step may involve the device sending the update data to the database or an entity operating the database. For example, the update data may characterize the newly detected feature points, for example in terms of appearance and in terms of location. In a specific example, the update data may comprise, for each new feature point, a descriptor characterizing the appearance of the respective feature point and a coordinate in the coordinate system used by the anchor point data to define the location of the respective feature point. In another example, updates may also comprise or indicate changes based on current detected feature points, such as the absence of reference feature points from the set of detected feature points or by adding metadata to new or existing detected feature points.
“Update anchor point data” 350: This step may involve the anchor point data being updated based on the update data. For example, the newly detected feature points may be added to the anchor point data as new reference feature points.

The method 300 of FIG. 7 refers to the example of newly detected feature points being missing in the current anchor point data and being nevertheless relevant for the placement of the anchor point. It will be appreciated that various other differences may exist between the detected feature points and the reference feature points of a selected anchor points due to various changes in the physical environment.

With continued reference to FIG. 4, there may be an additional object present in the scene. When an object, being a sofa in the FIG. 4 example, is added to a scene, this may result in new feature points being detected on the object and at the boundary of the object, e.g., at its corners or where the legs meet the floor. However, the new object may also occlude existing feature points which were included in the anchor point data. Whether such existing feature points are occluded may be viewpoint dependent, in that it may depend on the position and orientation of the camera with respect to the scene. As the device may succeed in selecting an anchor point for augmentation of the scene, e.g., using the feature points that are still detectable from the set of reference feature points from before the addition of the sofa, the detected feature points associated with the sofa may be added as an update to the existing anchor point data, which may previously have pertained only to the painting or the painting, the door, and the window. When updating the anchor point data, existing feature points which are now occluded may be marked accordingly. Such marking may be advantageous compared to the mere removal from the anchor point data since the occluded reference feature points may still be visible from other viewpoints. An example of such marking is a flag indicating ‘occluded’ or ‘potentially occluded’. Another example is that the anchor point data may indicate from which angles and/or distances a reference feature point is visible or not visible, or may define a 3D ‘blocking’ object which may allow the device to determine which reference feature points may be occluded from its current viewpoint, e.g., using ray casting. Such information may be more detailed or extensive when the user is moving around the scene compared to when the user stays at a fixed location.

With continued reference to FIG. 5, an object may be removed from the scene, such as a painting. When an object is removed from the scene, the reference feature points located on that object or at the boundary of the object may disappear from the scene. Nevertheless, the device may succeed in selecting an anchor point for augmentation of the scene, for example based on other reference feature points which may still be present in the scene. Via the update data provided by the device, the reference feature points which have disappeared from the scene may be deleted from the anchor point data or marked, e.g., as ‘absent’ or ‘potentially absent’ or assigned a lower weight, which weight may be used by the device when determining a match quality. It is further noted that the removal of an object may also introduce new feature points by revealing an area behind the removed object. Accordingly, the removal of an object may reveal feature points that were previously used and may be re-instated, or may reveal new feature points that may now be added to the anchor point data.

Yet another example of a change in the physical environment is a change in lighting conditions. For example, a scene may become harder to recognise when the lighting in the scene changes. Feature point detection is often based on differences between lighter and darker areas near corners and edges. If the lighting becomes less, e.g., the scene becomes darker, the differences in dark/light between the areas which are relevant for feature point become less in an absolute sense, and the device may have trouble detecting certain feature points. Nevertheless, the device may succeed in selecting an anchor point for augmentation of the scene and may still match reference feature points to detected feature points despite the latter's change in appearance. The update data may be indicative of this change in appearance, for example by indicating the changed lighting conditions or by providing a new descriptor for a feature point which better characterizes the appearance of the feature point in the new lighting conditions. The anchor point data may be updated accordingly, e.g., by replacing the existing descriptor of a reference feature point by the newly provided descriptor.

With continued reference to a new descriptor, it is noted that this new descriptor may be added to the anchor point data as a second (or third, etc.) descriptor. In such a case, metadata may be added to the descriptor which may characterize the scene and/or the acquisition of the scene and which may enable a device to determine when to use which descriptor. Such metadata is also described in the following.

In the update data and/or in the anchor point data, the anchor point and/or reference feature points may be provided with metadata. Such metadata may, when provided in the update data, assist in the updating of the anchor point data, and when provided in the anchor point data, assist in the matching of the reference feature points to detected feature points. The metadata may for example characterize the scene in which a feature point is detected or the acquisition of the one or more camera images of the scene, and may thus provide contextual information which may be used in the updating of the anchor point data and/or in the subsequent use of the anchor point data. For example, if all feature points have been detected by the device under same or similar conditions, these conditions may be added as metadata to the update data or to the anchor point data on an anchor point level, meaning that they apply to all feature points defined in the respective data. For example, the metadata may indicate a time of day, day of year, overall lightning condition, white balance, etc. The metadata may also be provided on a feature point level, for example to account for different feature points having been captured at different times. In such a case, contextual information may be added to individual feature points, or a default may be defined on the anchor point level which may be overruled by contextual information provided on the feature point level.

In such metadata, a feature point may be given a certain weight, e.g., a number between 0.0 and 1.0. A base algorithm to determine the weight of a feature point may involve using the percentage of devices that detect a certain reference feature point when detecting the anchor point as the weight. For example, reference feature points which are detected by all devices may be assigned a weight of 1.0 whereas reference feature points which are detected by half of all devices may be assigned a weight of 0.5, etc. When detecting anchor points, the weights may be used to optimise the detection of anchor points. For example, detected feature points may be compared with reference feature points in order of weight, and the comparison may be stopped once a match quality acceptance criterion has been reached. It is noted that the remaining feature points may still be compared for the purpose of generating the update data but without being taken into account in the selection of the anchor point.

Another example of metadata which may be provided for a feature point in the update data and/or the anchor point data is an identifier. A feature point may normally be identified by its coordinate. However, in some cases, several feature points may be assigned the same or a very similar coordinate. This may be explained with the following example: a thin object may have a feature point on its front and back, but in case the thickness of the object is negligible, both feature points may be assigned the same or a very similar coordinate. In such cases, it may be helpful to provide each feature point a separate and unique identifier in the update data and/or the anchor point data. This way, explicit reference may be made to a particular feature point, which may for example allow the update data to refer to a particular feature point.

Another example of metadata which may be provided for a feature point in the update data and/or the anchor point data is the direction(s) and/or or distance(s) from which the feature point is visible or not visible, e.g., by being occluded.

FIG. 8 shows an example of such metadata in which the metadata may indicate a visibility of feature points as a function of the Euler angle α. This Euler angle α may correspond to the yaw angle as indicated by the arrow in the coordinate system 80. The 360 degrees may be divided in parts, for example in 12 parts of 30 degrees as shown in FIG. 8, and for each part, it may be indicated if the feature point is visible (v), not visible/invisible (i) or unknown (u). FIG. 8 provides a visual illustration of this type of metadata. It will be appreciated, however, that such metadata may be simply defined as a string, e.g., ‘vviivvvuuuuu’ indicating the visibility status starting at 12 'o clock and proceeding in clockwise direction, or numerically or in any other form. When providing such metadata, also the location to this metadata pertains may be provided, for example in form of a coordinate.

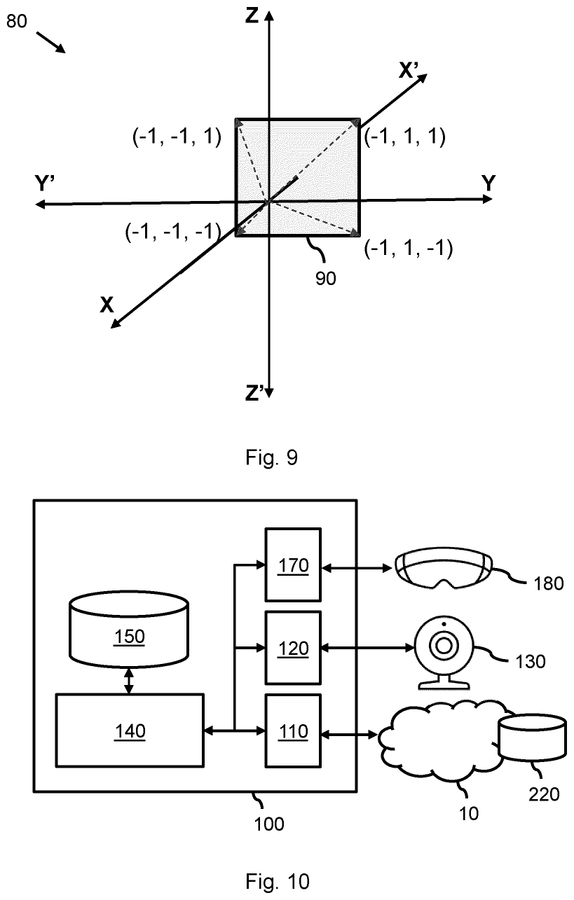

FIG. 9 shows another example of metadata which may be provided to indicate from which direction(s) and/or or distance(s) a feature point is visible or not visible. In this example, in the metadata, a viewing cone 90 may be defined for a feature point, which viewing cone 90 may indicate the visibility of the feature point. For example, the viewing cone 90 may be defined as vectors in a coordinate system 80, for example by the vectors (−1, 1, 1), (−1, −1, 1), (−1, 1, −1) and (−1, −1, −1). The feature point itself may correspond to the position (0, 0, 0) in the coordinate system 80. The viewing cone 90 may indicate the visibility of the respective feature point, in that the feature point may be visible from viewing directions which fall within the viewing cone 90. Alternatively, the viewing cone 900 may indicate the non-visibility of a feature point, in that the feature point may be visible from viewing directions which fall outside the viewing cone. In addition to defining a viewing cone, also one or more distances may be defined. For example, if a table occludes a feature point near the ground, the feature point may be set as ‘visible’ for a viewing cone for distances up to 1 meter (e.g., as metadata “(0, 1)”) and invisible for all other distances (e.g., as metadata “(1, −)”). It will be appreciated that other shapes and forms and methods of indicating visibility or invisibility of feature points in a 3D coordinate system may also be used.

In general, the metadata may be provided in the update data and/or the anchor point data in any suitable form, for example encoded in XML or JSON or as an object in a particular programming language.

The following continues to refer to the update data and to the metadata which may be included in the update data and/or in the anchor point data. An update may in general indicate a change in the anchor point data. Such changes may include the addition or removal of feature points. Update data may for example comprise:
Feature point identification, e.g., a coordinate or other identifier;
An action on the feature point, e.g., addition or removal.

When updating the anchor point data based on such update data, the current date/time may be added as metadata to a respective feature point so as to indicate a date/time of ‘last change’. Furthermore, instead of deleting a feature point from the anchor point data, the feature point may be set as ‘inactive’ as opposed to ‘active’. This way, feature points may be preserved, and the history of changes may be tracked in time, enabling the anchor point data to be restored to a particular date/time. It will be appreciated that a change in status, e.g., from ‘active’ to ‘inactive’, or any other change in the anchor point data, may be effected only once a sufficient number of devices indicate the same or a similar change. For example, a feature point may be set to ‘inactive’ only after a number of devices report the feature point as missing. Another example is that a feature point may be added to the anchor point data in response to update data from a device, but may still be labelled ‘inactive’ while indicating the date/time of the update and optionally other relevant metadata. Only after a number of devices report the additional feature point, the feature point may be set as ‘active’ and thereby become a reference feature point for the respective anchor point.

When providing anchor point data to a device, inactive feature points may either be included in or excluded from the anchor point data depending on a configuration of the database or the entity operating the database (which entity may also be referred to as an ‘anchor point system’ or as the system providing the anchor points from the database to, and receiving the update data from, the device). By including inactive feature points, a device may be enabled to match detected feature points to inactive reference feature points and indicate a positive match in an update.

In the anchor point data, reference feature points which may be considered to belong together may be grouped to form a feature point group. Such grouping may for example be relevant for feature points that belong to an object that can be moved and is moved at least occasionally. The anchor point system may detect, for example by analysing a history of changes in feature points, that certain feature points move at the same time and that these feature points only change position relative to other feature points but not relative to each other. By grouping features points, e.g., by using a group identifier or by adding them as an array or list with a separate identifier as a composite feature point, a device may, when some feature points of the object are detected at a certain location, take this into account when matching other reference feature points from the same group. This may improve the speed of detecting the other reference feature points and/or may improve the reliability of such detection and/or accurately and efficiently conclude that a reference feature point is occluded when another reference feature point of the feature point group is still present.

Feature points may also be grouped by providing semantic information. For example, feature points which belong to an object may be described in the anchor point data and/or in the update data by referring to a description of the object. For example, the anchor point data may indicate a group of feature points as belonging to a chair. The device may then use computer vision algorithms to detect a chair in the scene and may match this chair to the chair referenced in the anchor point data. The measures described in this specification which pertain to individual feature points may also apply to a group of feature points belonging to an object. For example, the feature points of a particular object may be removed from the anchor point data if the device reports the object as ‘not found’, or feature points of newly detected objects may be added to the anchor point data if one or more devices report a newly detected object in the scene. Even when the device locates anchor points using only semantic information in the scene, for example by the device being provided with a reference set of objects, their description, position, and orientation in the scene and by the device detecting objects in the camera images and comparing the detected objects to the reference set of objects, updates may still be provided. These updates may for example reflect the addition or removal of an object from the scene, but may also reflect visible changes in the objects, for example due to changes in lighting conditions or other visible changes.

In general, updates to anchor points may be initially made as addition to the current anchor point data, for example by adding an additional anchor point or an additional sub-version or layer to an existing anchor point. Once an update is deemed to be (semi-)permanent, the existing anchor point data may be modified. Whether an update is deemed (semi-)permanent may depend on various factors such as:
What is the chance of reverting to a previous state? For example, if an object is added to a scene, what is the chance that the object will be removed later on? An object that has been present in a scene for months is more likely to be present the next day than a newly detected object. Semantic information, which may be obtained using object recognition, may be used when predicting the aforementioned chance.
What is the chance of a further change in the scene, for example another object being added or removed? Or what is the chance of the lighting conditions changing again? A scene that has changed frequently in the past may be deemed to be more likely to change in the future, compared to a scene that has seen no change at all for a prolonged period of time.

The anchor point system may algorithmically determine whether to update the existing anchor point data, for example by estimating one or more of the above chances. The decision may also depend on the number of devices visiting a particular area. For example, the anchor point data for an area which is frequently visited and thereby frequently captured by devices may be more readily updated as new update data will be received soon. Conversely, the anchor point data in an area which is seldomly visited and thereby infrequently captured by devices may be less readily updated as update data may be obtained only very infrequently, which means that an incorrect update to the existing anchor point data may be more difficult to correct.

In some embodiments, a device may be requested, e.g., by the anchor point system, to provide update data, instead or additionally to the device providing the update data out of its own volition. Namely, in an area visited by many devices, it may not be needed for all devices to provide update data to the anchor point system. As such, only a subset of the devices may be requested to provide the update data. Another example is that a device may be requested to provide update data only in certain conditions, e.g., during specific lighting conditions, specific times, etc. These conditions may be signalled by the anchor point system to the device. Alternatively, the condition may be reported by the device to the anchor point system and the anchor point system may request the update data in response to the reported condition.

In some embodiments, the anchor point system may request the device to capture other parts of the scene with its camera, for example as the anchor point data pertaining to these parts may be outdated or since conflicting updates have been reported from other devices. This request may be relayed by the device to the user to cause the user to point the camera of the device to these other parts of the scene, e.g., by directly requesting the user or by nudging or in some way rewarding the user.

In some embodiments, the device may delay determining and sending the update data until the device has a substantial and stable 3D feature point map of the scene. This way, it may be avoided that numerous smaller updates are sent. Also, if the capture and analysis was thorough enough, the update data may distinguish between a feature point being occluded only from certain angles versus a feature point being entirely occluded or removed from the scene. In case a feature point is occluded from certain angles, a thorough capture and analysis may also allow the device to indicate these angles, for example in form of metadata as described with reference to FIGS. 8-9.

FIG. 10 shows a device 100 configured to augment a scene by overlaying graphical elements over the scene. The device 100 is shown to comprise a database interface to a database comprising anchor point data as described elsewhere in this specification. In the example of FIG. 10, the database interface is a network interface 110 through which the device 100 can access a network-accessible database 220, e.g., via the internet 10. The network interface 110 may for example be a wireless network interface configured to connect to a 4G, 5G or later generation mobile network, or to a Wi-Fi access point, etc. In other examples, the network interface 110 may be a wired network interface, such as an Ethernet or fibre-optic based interface.

The device 100 is further shown to comprise a camera interface 120 to a camera 130 to acquire one or more camera images of a scene. In the example of FIG. 10, the camera is shown to be an external camera 130. In such a case, the camera interface 120 may for example be a USB interface to a USB camera or a WiFi-based network interface to a Wi-Fi based camera. In a specific example, the camera may be integrated into an external display. In other examples, the camera 130 may be an internal camera of the device 100, in which case the camera interface 130 may be an internal interface of the device 100, such as a low-level electrical parallel interface providing data lines, a clock and synchronization, or a camera serial interface (CSI).

The device 100 may further comprise a processor subsystem 140 which may be configured, e.g., by hardware design or software, to perform the operations described in this specification in as far as pertaining to the device or the augmentation of a scene. In general, the processor subsystem 140 may be embodied by a single Central Processing Unit (CPU), such as a x86 or ARM-based CPU, but also by a combination or system of such CPUs and/or other types of processing units, such as Graphics Processing Units (GPUs). The device 100 may further comprise a display interface 170 for outputting display data to a display 180. Using the display interface 170, the device 100 may display graphical elements to augment the scene. Although shown as an external display, the display 180 may alternatively be an internal display of the device 100, and in general, may be head-mounted or non-head mounted. In some embodiments, the device 100 may further comprise one or more sensors, such as one or more accelerometers and/or gyroscopes, for example to detect a position and orientation of the device 100 with respect to the physical environment and thus the scene. For example, such accelerometers and gyroscopes may be provided in form of an inertial measurement unit (IMU). Additionally, or alternatively, the display 180 may comprise the sensor(s), for example if the display 180 is a head-worn display which comprises the camera 130. In such embodiments, the device 100 may access the acquired sensor data, e.g., via the display interface 170 or the camera interface 120.

As also shown in FIG. 10, the device 100 may comprise a data storage 150 for storing data, including but not limited to the obtained anchor point data and the generated update data. The data storage 150 may take various forms, such as a solid-state drive, an embedded memory card, a flash memory, a volatile memory, etc.

In general, the device 100 may be embodied by a (single) device or apparatus, e.g., a smartphone, personal computer, laptop, tablet device, gaming console, set-top box, television, monitor, projector, smart watch, smart glasses, AR headset, VR headset, XR headset, media player, media recorder, etc. In some examples, the device 100 may be a so-called User Equipment (UE) of a mobile telecommunication network, such as a 4G, 5G or next-gen mobile network. In other examples, the device 100 may be an edge node of a network, such as an edge node of the aforementioned mobile telecommunication. In such examples, the device 100 may lack a display output, or at least may not use the display output to display the graphical elements for augmentation of the scene. Rather, the device may render the graphical elements, which may then be made available for streaming to a further downstream device, such as an end-user device. In such examples, the device 100 may also obtain the camera images of the scene from a downstream device, for example the same end-user device, or directly from a camera.

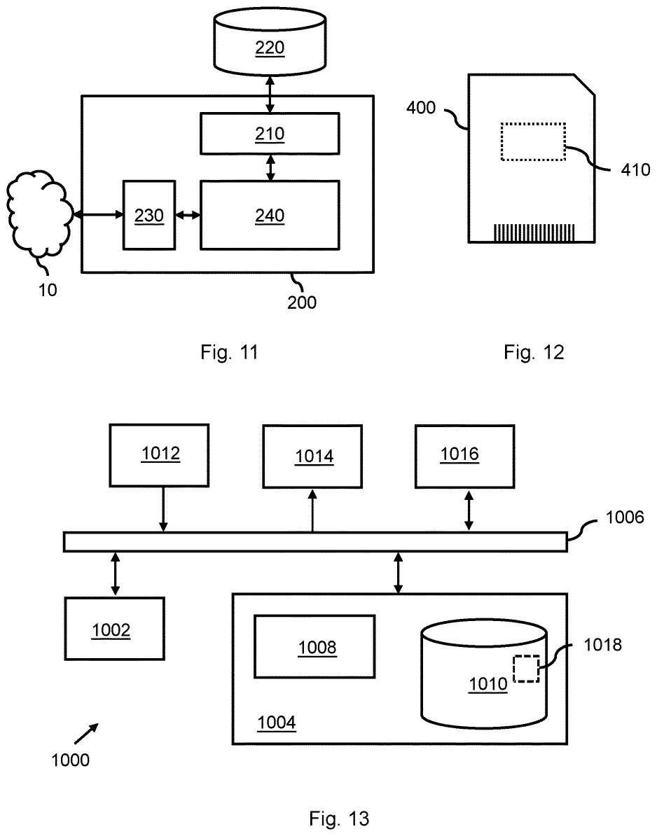

FIG. 11 shows a system 200 configured to provide anchor point data to a device as described in this specification. The system 200 may elsewhere also be referred to as an ‘anchor point system’. The system 200 may comprise a database interface 210 to a database 220 which comprising anchor point data as described elsewhere in this specification. In the example of FIG. 11, the database 220 is an external database. In such a case, the database interface 210 may for example be a network interface to a network-accessible data storage containing the database (which may elsewhere also simply be referred to as a ‘network-accessible database’) or a USB interface to a USB data storage, etc. In other examples, the database 220 may be an internal database of the system 200, for example stored on an internal data storage, in which case the database interface 210 may be an internal interface of the system 200, such as a data storage interface. The system 200 may further comprise a network interface 230 for data communication to the device of FIG. 10, for example via the internet 10. The network interface 230 may for example be a wired communication interface, such as an Ethernet or fiber-optic based interface, to a fixed (e.g., non-mobile) part of a mobile telecommunications network. Alternatively, the network interface 230 may be a wireless communication interface. In yet other examples, the system 200 may be a subsystem of a larger system, e.g., a supra-system implementing several functions. In such cases, the network interface 230 may be an internal interface of the supra-system, for example a virtual, software-based network interface. The system 200 may further comprise a processor subsystem 240 which may be configured, e.g., by hardware design or software, to perform the operations described in this specification in as far as pertaining to providing anchor point data to a device and for updating the anchor point data based on update data received from the device.

In general, the processor subsystem 240 may be embodied by a single Central Processing Unit (CPU), such as a x86 or ARM-based CPU, but also by a combination or system of such CPUs and/or other types of processing units. In embodiments where the system 200 is distributed over different entities, e.g., over different servers, the processor subsystem 240 may also be distributed, e.g., over the CPUs of such different servers. Although not shown in FIG. 11, the system 200 may comprise a data storage, such as a hard drive, a solid-state drive, or an array of such hard and/or solid-state drives, etc., which may be used to store data, such as the aforementioned database comprising anchor point data. In some examples, the system 200 may be implemented by a network node, or by a system of network nodes.

In general, each entity described in this specification may be embodied as, or in, a device or apparatus. The device or apparatus may comprise one or more (micro) processors which execute appropriate software. The processor(s) of a respective entity may be embodied by one or more of these (micro) processors. Software implementing the functionality of a respective entity may have been downloaded and/or stored in a corresponding memory or memories, e.g., in volatile memory such as RAM or in non-volatile memory such as Flash. Alternatively, the processor(s) of a respective entity may be implemented in the device or apparatus in the form of programmable logic, e.g., as a Field-Programmable Gate Array (FPGA). Any input and/or output interfaces may be implemented by respective interfaces of the device or apparatus. In general, each functional unit of a respective entity may be implemented in the form of a circuit or circuitry. A respective entity may also be implemented in a distributed manner, e.g., involving different devices or apparatus.

It is noted that any of the methods described in this specification, for example in any of the claims, may be implemented on a computer as a computer implemented method, as dedicated hardware, or as a combination of both. Instructions for the computer, e.g., executable code, may be stored on a computer-readable medium 400 as for example shown in FIG. 12, e.g., in the form of a series 410 of machine-readable physical marks and/or as a series of elements having different electrical, e.g., magnetic, or optical properties or values. The executable code may be stored in a transitory or non-transitory manner. Examples of computer-readable mediums include memory devices, optical storage devices, integrated circuits, servers, online software, etc. FIG. 12 shows by way of example a memory card 400.

FIG. 13 is a block diagram illustrating an exemplary data processing system 1000 that may be used in the embodiments described in this specification. Such data processing systems include data processing entities described in this specification, including but not limited to a device for augmenting a scene and a system for providing anchor point data to the device. The data processing system 1000 may include at least one processor 1002 coupled to memory elements 1004 through a system bus 1006. As such, the data processing system may store program code within memory elements 1004. Furthermore, processor 1002 may execute the program code accessed from memory elements 1004 via system bus 1006. In one aspect, data processing system may be implemented as a computer that is suitable for storing and/or executing program code. It should be appreciated, however, that data processing system 1000 may be implemented in the form of any system including a processor and memory that is capable of performing the functions described within this specification. The memory elements 1004 may include one or more physical memory devices such as, for example, local memory 1008 and one or more bulk storage devices 1010. Local memory may refer to random access memory or other non-persistent memory device(s) generally used during actual execution of the program code. A bulk storage device may be implemented as a hard drive, solid state disk or other persistent data storage device. The data processing system 1000 may also include one or more cache memories (not shown) that provide temporary storage of at least some program code in order to reduce the number of times program code is otherwise retrieved from bulk storage device 1010 during execution.

Input/output (I/O) devices depicted as input device 1012 and output device 1014 optionally can be coupled to the data processing system. Examples of input devices may include, but are not limited to, for example, a microphone, a keyboard, a pointing device such as a mouse, a game controller, a Bluetooth controller, a VR controller, and a gesture-based input device, a touchscreen, a hand tracker, or the like. Examples of output devices may include, but are not limited to, for example, a monitor or display, speakers, or the like. Input device and/or output device may be coupled to data processing system either directly or through intervening I/O controllers. A network adapter 1016 may also be coupled to data processing system to enable it to become coupled to other systems, computer systems, remote network devices, and/or remote storage devices through intervening non-public or public networks. The network adapter may comprise a data receiver for receiving data that is transmitted by said systems, devices and/or networks to said data and a data transmitter for transmitting data to said systems, devices and/or networks. Radios, modems, cable modems, and ethernet cards are examples of different types of network adapter that may be used with data processing system 1000.

As shown in FIG. 13, memory elements 1004 may store an application 1018. It should be appreciated that data processing system 1000 may further execute an operating system (not shown) that can facilitate execution of the application. The application, being implemented in the form of executable program code, can be executed by data processing system 1000, e.g., by processor 1002. Responsive to executing the application, the data processing system may be configured to perform one or more operations to be described herein in further detail.

For example, data processing system 1000 may represent a device for augmenting a scene as described in this specification. In that case, application 1018 may represent an application that, when executed, configures data processing system 1000 to perform the functions described with reference to the device. In another example, data processing system 1000 may represent an embodiment of a system for providing anchor point data to the device. In that case, application 1018 may represent an application that, when executed, configures data processing system 1000 to perform the functions described in this specification with reference to the system.

An abstract for the present specification may read as follows: A device may be provided for augmenting a scene by overlaying graphical elements over the scene. The device may make use of anchor points to determine where to overlay the graphical elements over the scene. A system may be provided which may provide anchor point data of one or more anchor points to the device. The device may use a camera to acquire camera image(s) of the scene, detect feature points in the camera image(s), match the detected feature points to reference feature points of the anchor points, and in case of a match, select a respective anchor point for use in the augmentation. The device may further generate and provide update data back to the system. The update data may be indicative of a difference between the detected feature points and reference feature points of the selected anchor point. This way, the anchor point data may be updated based on the update data, e.g., to account for changes in the physical environment of the scene or changes in the capture.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or stages other than those stated in a claim. The article “a” or “an” preceding an element does not exclude the presence of a plurality of such elements. Expressions such as “at least one of” when preceding a list or group of elements represent a selection of all or of any subset of elements from the list or group. For example, the expression, “at least one of A, B, and C” should be understood as including only A, only B, only C, both A and B, both A and C, both B and C, or all of A, B, and C. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A device for augmenting a scene by overlaying graphical elements over the scene, comprising:
a database interface to a database, wherein the database comprises anchor point data of anchor points for use in scene augmentation, wherein the anchor point data of a respective anchor point defines the anchor point at least in part as a coordinate in a coordinate system and in spatial relationship to a set of reference feature points which are defined in the anchor point data and listed as further coordinates in the coordinate system;
a camera interface to a camera to acquire one or more camera images of a scene;
a processor subsystem configured to:
via the database interface, obtain anchor point data of anchor points;
detect feature points from the one or more camera images to obtain detected feature points and coordinates of the detected feature points;
match the detected feature points to the set of reference feature points of one or more of the anchor points to obtain one or more quantifications of match quality, and if the match quality between a set of detected feature points and the set of reference feature points of an anchor point satisfies a match quality acceptance criterion, select the anchor point to augment the scene;
wherein the processor subsystem is further configured to provide update data back via the database interface, wherein the update data is indicative of a difference between the set of detected feature points and the set of reference feature points of said selected anchor point.

2. The device according to claim 1, wherein the processor subsystem is configured to identify, in the update data, which one or more reference feature points are not matched to the set of detected feature points.

3. The device according to claim 1, wherein the processor subsystem is configured to identify, in the update data, which one or more detected feature points are not matched to the set of reference feature points.

4. The device according to claim 1, wherein the processor subsystem is configured to identify a feature point in the update data by providing a coordinate of the feature point in the coordinate system.

5. The device according to claim 1, wherein the anchor point data comprises a reference descriptor for a respective reference feature point, wherein the reference descriptor characterizes an appearance of the respective feature point, wherein the processor subsystem is configured to generate a descriptor for a respective detected feature point to obtain a generated descriptor and to determine the match quality between the respective reference feature point and the respective detected feature point at least in part based on a correspondence between the reference descriptor and the generated descriptor.

6. The device according to claim 5, wherein the processor subsystem is configured to identify, in the update data:
if the correspondence does not satisfy a correspondence criterion; or
if the respective detected feature point is detected after, or only after re-generating the generated descriptor using a different configuration of a feature detector, wherein optionally, the update data is generated to indicate the different configuration of the feature detector and/or said re-generated descriptor.

7. The device according to claim 1, wherein the processor subsystem is configured to determine, if a reference feature point is not matched to the set of detected feature points in at least one of the one or more camera images, whether a feature corresponding to the reference feature point is occluded in the at least one of the one or more camera images, and if so, indicate in the update data that the feature is occluded, wherein the processor subsystem is configured to determine said occlusion by detecting the feature in another camera image of the scene which other camera image shows the scene from a different position and/or orientation.

8. The device according to claim 1, wherein the processor subsystem is configured to include, in the update data, metadata which characterizes the scene or said acquisition of the one or more camera images of the scene, wherein the metadata indicates for example one or more of: a time of day of the acquisition of the one or more camera images, a date of the acquisition of the one or more camera images, a light or brightness level detected by the camera, a light direction detected by the camera, a camera image from the one or more camera images, a reduced-size representation of the camera image, an orientation of the camera with respect to the scene, a lens characteristic of the camera used to capture the camera image, a contrast level in the camera image, and a dynamic range of the camera image.

9. The device according to claim 1, wherein the database interface is a network interface and wherein the database is a network-accessible database, for example hosted by a network server.

10. A system for providing anchor point data to a device which is configured to augment a scene by overlaying graphical elements over the scene, comprising:
a database interface to a database, wherein the database comprises anchor point data of anchor points for use in scene augmentation, wherein the anchor point data of a respective anchor point defines the anchor point at least in part as a coordinate in a coordinate system and in spatial relationship to a set of reference feature points which are defined in the anchor point data and listed as further coordinates in the coordinate system;
a network interface;
a processor subsystem configured to, via the network interface:
send anchor point data of anchor points to the device to enable the device to select an anchor point to augment a scene by detecting feature points from the one or more camera images to obtain detected feature points and coordinates of the detected feature points and by selecting an anchor point from the anchor points based on a match quality between a set of detected feature points and a set of reference feature points of the anchor point;
receive update data from the device, wherein the update data is indicative of a difference between the set of detected feature points and the set of reference feature points of said selected anchor point;
based on the update data, update the anchor point data of the selected anchor point in the database.

11. The system according to claim 10, wherein the processor subsystem is configured to, if the update data identifies one or more detected feature points which are not matched by the device to the set of reference feature points, update the anchor point data of the selected anchor point by adding the one or more detected feature points as one or more new reference feature points to the anchor data.

12. The system according to claim 11, wherein the processor subsystem is configured to add the one or more new reference feature points in a separate data structure to the anchor data, which separate data structure is separate from a data structure storing the set of reference feature points.

13. The system according to claim 10, wherein the processor subsystem is configured to, if the update data identifies one or more reference feature points which are not matched by the device to the set of detected feature points, update the anchor point data of the selected anchor point by removing, marking, or adjusting a property of the one or more reference feature points in the anchor point data.

14. A computer-implemented method of augmenting a scene by overlaying graphical elements over the scene, comprising:
accessing a database, wherein the database comprises anchor point data of anchor points for use in scene augmentation, wherein the anchor point data of a respective anchor point defines the anchor point at least in part as a coordinate in a coordinate system and in spatial relationship to a set of reference feature points which are defined in the anchor point data and listed as further coordinates in the coordinate system;
from the database, obtaining anchor point data of anchor points;
using a camera, acquiring one or more camera images of a scene;
detecting feature points from the one or more camera images to obtain detected feature points and coordinates of the detected feature points;
matching the detected feature points to the set of reference feature points of one or more of the anchor points to obtain one or more quantifications of match quality, and if the match quality between a set of detected feature points and the set of reference feature points of an anchor point satisfies a match quality acceptance criterion, selecting the anchor point to augment the scene; and
providing update data back via the database interface, wherein the update data is indicative of a difference between the set of detected feature points and the set of reference feature points of said selected anchor point.

15. A computer-implemented method of providing anchor point data to a device which is configured to augment a scene by overlaying graphical elements over the scene, comprising:
accessing a database, wherein the database comprises anchor point data of anchor points for use in scene augmentation, wherein the anchor point data of a respective anchor point defines the anchor point at least in part as a coordinate in a coordinate system and in spatial relationship to a set of reference feature points which are defined in the anchor point data and listed as further coordinates in the coordinate system;
sending anchor point data of anchor points to the device to enable the device to select an anchor point to augment a scene by detecting feature points from the one or more camera images to obtain detected feature points and coordinates of the detected feature points and by selecting an anchor point from the anchor points based on a match quality between a set of detected feature points and a set of reference feature points of the anchor point;
receiving update data from the device, wherein the update data is indicative of a difference between the set of detected feature points and the set of reference feature points of said selected anchor point;
based on the update data, updating the anchor point data of the selected anchor point in the database.

16. A transitory or non-transitory computer-readable medium comprising data representing a computer program, the computer program comprising instructions for causing a processor system to perform the method according to claim 14.
